(19) United States
(12) Patent Application Publication
(10) Pub. No.: US 2023/0112289 A1
(43) Pub. Date: Apr. 13, 2023

(54) ASSEMBLY COMPRISING A VALVE AND AT LEAST ONE CONNECTOR

(71) Applicant: ASCO SAS, LUCÉ (FR)

(72) Inventor: Thiago CAETANO, Paris (FR)

(21) Appl. No.: 17/912,149

(22) PCT Filed: Mar. 16, 2021
(86) PCT No.: PCT/EP2021/056616

§ 371 Date: Sep. 16, 2022

(30) Foreign Application Priority Data
Mar. 19, 2020 (FR) 20 02687

(51) Int. Cl. F16K 37/00

(52) U.S. Cl. CPC F16K 37/0083

(57) ABSTRACT

Disclosed is an assembly comprising a valve and a connector. The assembly (1) comprising: - a valve (10); - a monitoring circuit (4); - at least one connector (2) intended to be placed upstream or downstream of the valve (10), comprising at least one sensor and a communication circuit for transmitting data, to the monitoring circuit (4), that relates to a measurement carried out by the sensor, the monitoring circuit (4) being designed to transmit said data to a processor outside the assembly and/or to generate operating diagnostic information of the valve on die basis of the transmitted data.

The present invention relates to valves, and more particularly but not exclusively those used in industry, for controlling a flow of a fluid, for example a liquid.

Valves equipped with a control box receiving an information for controlling the valve are known.

These valves are for example motorized valves, comprising a motor for moving a shutter in the body of the valve, or solenoid valves.

The control box may comprise an electronic circuit for controlling the actuator of the valve, and one or more sensors which provide information on the operation of the valve.

However, the one or more present sensors may turn out to be insufficient for providing all the information which could be useful for maintaining the installation or for adding supplementary functions, for example a detection function.

Thus, possibilities for developing the installation remain limited, unless the valves are replaced with new ones having additional functions.

WO 2018/219408 discloses a sanitary installation which is electrically powered in the normal case by an electrical power grid and is configured to allow regular hygienic rinsing of the installation according to a predefined interval of time. This installation comprises a valve which is connected to the connector of a tap by the water pipe. The connector is fitted with an electrically controlled stop valve and with a first communication unit, which communicates with a second communication unit of the valve. In order to ensure regular rinsing in the event that the electrical power grid is cut off, the installation furthermore comprises a pressure sensor and a supplementary electrical power supply for the valve. The sensor, configured to detect the water pressure in the pipe, may comprise a third communication unit which is able to communicate with the above-mentioned first communication unit. During the cut-off, when the pressure detected by the sensor falls below a predefined value during the opening of the tap, the installation controls the opening of the valve in order to allow water to flow into the installation to perform rinsing.

TWM536314 discloses a valve for a gas pipe comprising a sensor, a microprocessor receiving information from the sensor and a wireless communication means which allows the microprocessor to control a control module of the valve.

DE 197 11 937 discloses a system for supplying liquid fuels to service stations. The system comprises a valve and a pump which are electrically controlled by a control device. The system comprises sensors connected to the control device.

CA 2 129 470 discloses a valve comprising a flow sensor which is able to be added to a unit for regulating the valve or a vortex sensor which is able to be integrated into a flange of a body of the valve.

US 5 197 328 discloses testing and determining the operating conditions of a pneumatic valve by way of a diagnostic controller. The valve comprises pressure and position sensors which provide electrical output signals to the controller.

US 9 037 281 discloses a valve controller combined with an actuator. The valve comprises pressure sensors connected to the controller.

US 2014/225014 discloses an assembly comprising a valve, sensors and a control circuit which is designed to communicate with a base station or an automatic measurement reading network.

There is a need to facilitate the development of an installation by allowing the addition of new functions, if this is sought.

There is also a need to have available a solution which allows an installation having additional measurement means and/or measurement means of increased reliability to be realized.

The invention aims to meet all or some of these needs and relates to an assembly comprising:
a valve,
a circuit for monitoring the valve, and
at least one connector intended to be placed upstream or downstream of the valve, comprising at least one sensor and a communication circuit for transmitting to the monitoring circuit data relating to a measurement carried out by the sensor, the monitoring circuit being designed to transmit said data to a processor outside the assembly and/or to generate at least one diagnostic information regarding operation of the valve on the basis of the data transmitted by the connector.

“Diagnostic information” means any information which allows a malfunction of the valve and/or of the installation which comprises it to be detected and/or preventative maintenance to be carried out.

“Processor outside the assembly” means a processor which is not borne by the valve or the connector. A processor connected to the monitoring circuit by a wired link in order to allow data to be transmitted from the monitoring circuit is not borne by the valve or the connector. Such a processor is for example present on a mobile device or within a system for controlling the installation comprising the valve.

The invention allows at least one additional sensor to be easily introduced into an installation by making use of the presence of the circuit for monitoring the valve to at least partially process and/or transmit the measurement data. Thus, the connector may be realized more simply.

Furthermore, the invention is suitable for a modular design which makes it possible to have for example a valve and a monitoring circuit which are common to a plurality of connectors equipped with different sensors or with more or fewer sensors. Thus, it is possible, according to the circumstances, to use one and the same valve with different connectors, chosen from a group of available connectors, according to the functions that it is desired to add to the valve. The valve may be equipped with a monitoring circuit which remains the same, whereas connectors comprising different sensors may be used, according to the functions that it is sought to add to the valve.

The valve comprises a shutter which is preferably actuated by an actuation unit. The latter may actuate the valve electrically, magnetically, thermally, pneumatically or hydraulically. The actuation unit may be attached to the body of the valve.

The monitoring circuit may be separable from the actuation unit, the monitoring circuit being for example present within a casing which may be removably attached to the valve, or within an electronic card which may be removably received within a casing of the valve.

The actuation unit may be configured to control the valve as a function at least of the one or more diagnostic information generated by the monitoring circuit.

The valve may be an angle seat valve, a solenoid valve or a thermal valve.

The communication circuit of the connector may be connected to the monitoring circuit by a wired link. As a variant, the communication circuit is connected to the monitoring circuit by a wireless link.

The communication circuit of the connector may be powered by an internal energy source, in particular a pre-charged cell or battery or a device for generating energy, which draws energy for example from external sources of low-power energy, this energy being stored for use in the autonomous operation of the communication circuit.

The communication between the communication circuit of the connector and the monitoring circuit may be made by low-energy near-field communication (NFC) technology.

The above-mentioned data preferably comprise at least one information concerning a parameter of the fluid flowing through the valve, the sensor being configured to measure for example at least one of a temperature, a pressure of the fluid, an amplitude and/or frequency of vibration, in particular noise, of the fluid, of the connector or of a pipe connected thereto and/or of a portion of the valve.

The monitoring circuit may be configured to measure at least one of a position of the valve, a control pressure in the case of an angle seat valve, a current in the case of a solenoid valve and/or a local temperature.

The monitoring circuit preferably comprises a processor configured to process the data coming from the sensor and to provide, in particular to any means for directly or indirectly controlling the valve, for example to the above-mentioned actuation unit, at least one information on at least one operating condition of the valve, in particular an information on the response time of the valve and/or the number of operating cycles that have passed or are remaining until maintenance.

In a variant, the monitoring circuit retransmits the data, which have been transmitted to it by the communication circuit of the connector, to a processor outside the assembly, the latter being configured to generate diagnostic information regarding operation of the valve on the basis of the transmitted data, for example to generate a command relating to the maintenance of the valve.

The monitoring circuit may be configured to be connected, in particular by a wireless link, to a means for displaying the diagnostic information regarding operation of the valve, preferably outside the assembly. In particular, the display means may form part of a device comprising said processor outside the assembly, configured to process said data and to generate diagnostic information regarding operation of the valve on the basis of the one or more transmitted data. This device is for example a portable device such as a tablet computer.

The monitoring circuit may be configured to provide at least one prediction about at least one future change in at least one operating condition of the valve, in particular from the correlation of said data and of at least one characteristic of the valve, where appropriate using at least one machine-learning algorithm.

The invention also relates, independently or in combination with the above, to an assembly comprising:
a valve,
a circuit for monitoring the valve, which may be removably attached to the valve, the monitoring circuit being designed to generate at least one diagnostic information regarding operation of the valve on the basis of data transmitted by one or more sensors integrated into the valve or present on at least one connector outside the valve, or to transmit to a processor outside the assembly data allowing at least one diagnostic information on the operation of the valve to be generated, these data transmitted to the external processor being generated by the circuit for monitoring the valve from data transmitted by one or more sensors integrated into the valve or present on at least one connector outside the valve.

According to this aspect of the invention, the monitoring circuit has a modular aspect and may receive information from all types of sensors, local or remote, and communicate processed information to a device outside the assembly, with a view to optimizing the maintenance and/or the safety of the installation comprising the valve.

The maintenance circuit, the valve, the connector and the one or more sensors may have all or some of the features described above.

The invention also relates to a connector intended to be placed upstream or downstream of a valve and a monitoring circuit, so as to form an assembly according to the invention.

The invention also relates to a method for monitoring a valve and/or an installation comprising this valve by way of a circuit for monitoring the valve, this method comprising the step of disposing, at least upstream or downstream of the valve, at least one connector comprising at least one sensor and a communication circuit for transmitting to the monitoring circuit data relating to a measurement carried out by the sensor, the monitoring circuit being designed to transmit said data to a processor outside the assembly comprising the valve, the monitoring circuit and the connector and/or to generate at least one diagnostic information regarding operation of the valve and/or of the installation on the basis of the transmitted data.

The monitoring circuit may in particular transmit, to any system for controlling the valve, data coming from measurements carried out by the connector.

Preferably, the method comprises the measurement, by the sensor, of at least one of a temperature, a pressure of a fluid flowing through the valve, and a vibration, in particular sound vibration, of the fluid, of the connector or of a pipe connected thereto and/or of a portion of the valve.

The method may comprise the measurement, by the monitoring circuit, of a position of the valve, of a control pressure in the case of an angle seat valve, of a current in the case of a solenoid valve and/or of a local temperature.

The method may comprise the processing, by a processor of the monitoring circuit, of the data coming from said sensor and the provision, in particular to a means for controlling the valve and/or the installation, for example to a unit for actuating the valve, of at least one information relating to at least one operating condition of the valve, in particular an information on the response time of the valve and/or the number of operating cycles that have passed or are remaining until maintenance, the method preferably comprising the provision, by the processor, of at least one prediction about at least one future change in at least one operating condition of the valve, in particular from the correlation of said data and of at least one characteristic of the valve, where appropriate using at least one machine-learning algorithm.

### BRIEF DESCRIPTION OF THE DRAWINGS

The invention will be able to be better understood upon reading the following detailed description of non-limiting exemplary implementations thereof, and upon examining the appended drawing, in which:

FIG. 1 schematically and partially shows an example of an assembly according to the invention,

FIG. 2 schematically and partially shows, in axial section, an example of a connector according to the invention,

FIG. 3 schematically and partially shows an example of a variant of an assembly according to the invention.

### DETAILED DESCRIPTION

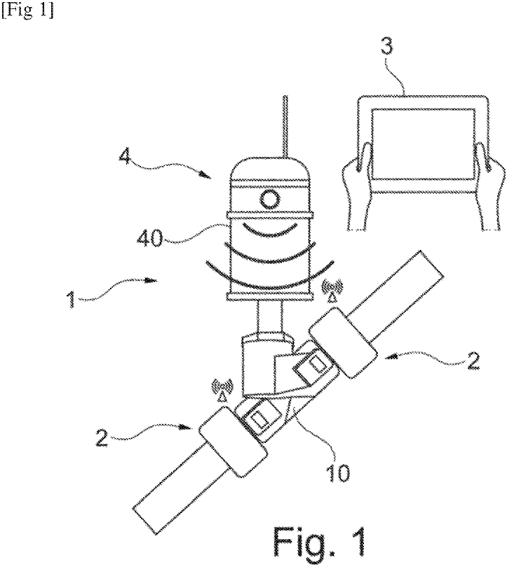

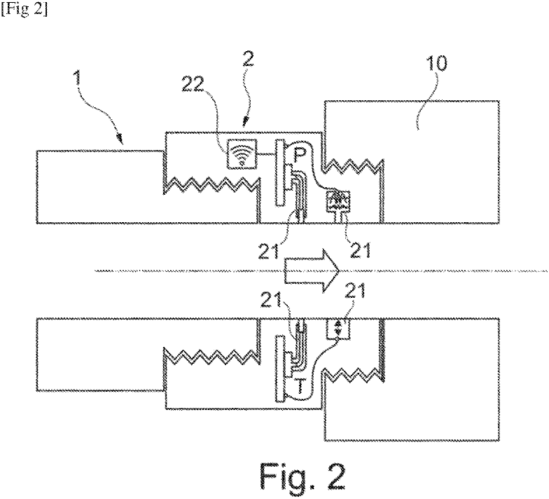

FIG. 1 shows an example of an assembly 1 according to the invention, comprising a valve 10, a casing 40 that houses a circuit 4 for monitoring the valve, and two connectors 2, respectively upstream and downstream of the valve 10. In a variant, the assembly comprises only one single connector 2, for example mounted upstream or downstream of the valve 10, as illustrated in FIG. 2.

In the example illustrated in FIG. 1, the valve 10 is an angle seat valve, the invention however not being limited to one particular type of valve and being able to be applied to other types of valves, for example a solenoid valve or a thermal valve. In the example illustrated in FIG. 2, the connector 2 is placed upstream of the valve 10, between the inflow or outflow pipe of the fluid and the seat of the valve 10.

The valve 10 comprises a unit for actuating the shutter, which unit is for example housed at least partially in the above-mentioned casing 40. This actuation unit converts for example a command signal for opening or closing the valve into a movement of the shutter of the valve.

Each connector 2 may comprise a male or female thread which is screwed to a corresponding female or male thread of the body of the valve 10. Each connector 2 preferably has two male ends, two female ends or one male end and one female end for connecting to a pipe and to the valve 10. These ends are preferably fitted with standard threads, for example conical or cylindrical threads, for example of metric type, in particular 5×10, 8×13, 12×17, 15×21, 20×27, 26×34, 33×42, 40×49 or 50×60, the invention however not being limited to one type of end or to one particular dimension of thread. The body of the valve 10 is preferably metallic, as are the connecting ends of each connector 2, but as a variant these are made of plastic. Where appropriate, the valve and the connector are equipped with quick-connection ends or conical-clamping ends. The connection may be made by way of a ring which is screwed.

As illustrated in FIG. 2, the connector 2 comprises at least one sensor 21 and a communication circuit 22 for transmitting to the monitoring circuit 4 data relating to a measurement carried out by the sensor 21. These data are preferably related to the fluid which is flowing. The monitoring circuit 4 is designed to generate diagnostic information regarding operation of the valve on the basis of the transmitted data.

The assembly may comprise a means 3 for displaying the generated diagnostic information regarding operation of the valve, as illustrated in FIG. 1.

Each connector 2 may comprise more than one sensor 21.

In the example illustrated in FIG. 2, the connector 2 comprises four sensors for measuring the temperature, the pressure of the fluid, a vibration and a noise, respectively.

The communication circuit 22 may be connected to the monitoring circuit 4 by a wireless link, as illustrated in FIGS. 1 and 2. This may in particular be realized using near-field wireless connection technologies of NFC type.

The monitoring circuit 4 may be configured to provide information on an operating parameter of the valve 10, and for example to measure a position of the shutter of the valve, a control pressure in the case of an angle seat valve, a current in the case of a solenoid valve and/or a local temperature.

The monitoring circuit 4 may comprise a processor configured to process the data coming from the sensors 21 of the connector 2, in order to provide additional information to the control system 3 and/or to have available an additional information on the behavior of the valve 10.

For example, it is possible, thanks to the information arising from the measurements carried out by the or each connector 2, to calculate parameters which otherwise would not have been able to be determined solely from the information coming from the valve 10 used without the connector 2.

This or these parameters calculated in this way concern for example the response time of the valve. It is possible to measure the response time between the arrival of the control signal and the actual closure or actual opening of the valve, for example, and from this information to detect any deviation from an expected value, which would for example be characteristic of a failure of the valve and/or of clogging thereof.

It is also possible to analyze the operational noise of the valve and to compare a detected spectral signature with an expected signature and, in the case of a difference beyond a predefined threshold, to generate an alert or to request that complementary measurements be carried out.

It is also possible to carry out measurements using the connector with a view to detecting a drop in pressure or a leak, and more generally any phenomenon which may be indicative of a malfunction of the valve or of the system in which the valve is included.

The information delivered by the or each connector 2, where appropriate combined with that coming from the valve 10 itself, may be used in the scope of predictive maintenance, and provide information for example on a future risk of a failure or a difference in the operating conditions with respect to a present situation.

These predictions may in particular concern a drop in pressure, a rise in operating temperature, a fault with the shutter of the valve, a change in the properties of the fluid which is flowing through the connector and the valve, and/or any other behavior of the valve.

The invention is not limited to the exemplary embodiments that have just been described.

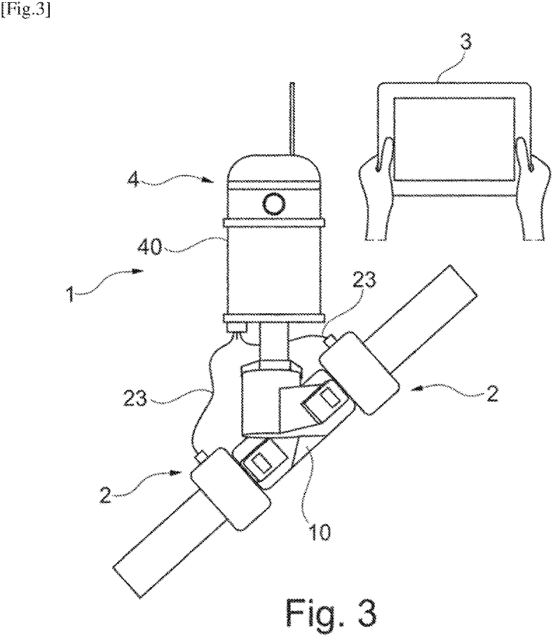

For example, the communication circuit 22 may be connected to the monitoring circuit 4 by a wired link 23, as illustrated in FIG. 3.

1-15. (canceled)

16. An assembly comprising:
a valve;
a monitoring circuit configured to monitor the valve;
a sensor configured to measure a parameter of the assembly and/or a parameter of a fluid flowing through the valve and generate corresponding measurement data; and
a communication circuit configured to transmit the measurement data to the monitoring circuit,
wherein the monitoring circuit is configured to transmit the measurement data to a processor disposed outside the assembly and/or to generate diagnostic information regarding operation of the valve based on the measurement data.

17. The assembly of claim 16, wherein the valve is an angle seat valve, a thermal valve, or a solenoid valve.

18. The assembly of claim 16, wherein the communication circuit is connected to the monitoring circuit by a wired link or a wireless link.

19. The assembly of claim 19, wherein the communication circuit is powered by an internal energy source.

20. The assembly of claim 19, wherein the communication circuit and the monitoring circuit are configured to communicate using low-energy near-field communication (NFC) technology.

21. The assembly of claim 19, wherein the internal energy source is a battery or a device for generating energy.

22. The assembly of claim 16, wherein the monitoring circuit is configured to be connected to a display configured to display the diagnostic information.

23. The assembly of claim 16, wherein the monitoring circuit is configured to measure at least one of a position of the valve, a control pressure of the valve, a current of the valve, and/or a local temperature of the valve.

24. The assembly of claim 16, wherein the monitoring circuit comprises a processor configured to process the measurement data and generate the diagnostic information.

25. The assembly of claim 24, wherein the diagnostic information comprises at least one of a response time of the valve, a number cycles the valve has operated, and/or a number of remaining operating cycles of the valve before maintenance.

26. The assembly of claim 16, wherein the monitoring circuit is configured to predict a change in at least one operating condition of the valve.

27. The assembly of claim 26, wherein the monitoring circuit is configured to predict the at least on change based a correlation of the sensor data and at least one characteristic of the valve, using a machine-learning algorithm.

28. The assembly of claim 16, further comprising:
a connector fluidly connected to the valve and disposed upstream or downstream of the valve with respect to a flow direction of a fluid through the valve; and
a casing attached to the connector,
wherein the sensor and the communication circuit are disposed in the connector and the monitoring circuit is disposed in the casing.

29. The assembly of claim 28, wherein the sensor comprises at least one sensor configured to measure (a) a temperature of the fluid, (b) a pressure of the fluid, and/or (c) an amplitude and/or frequency of (i) a vibration of the fluid, (ii) a vibration of the connector, (iii) a vibration of a pipe connected to the connector, and/or (iv) a vibration of the valve.

30. The assembly of claim 16, further comprising:
a first connector fluidly connected to the valve and disposed upstream of the valve with respect to a flow direction of a fluid through the valve; and
a second connector fluidly connected to the valve and disposed downstream of the valve with respect to the flow direction of a fluid through the valve,
wherein the sensor comprise a first sensor disposed in the first connector and a second sensor disposed in the second connector, and
wherein the communication circuit comprises a first communication circuit disposed in the first connector and a second communication circuit disposed in the second connector.

31. A method of monitoring a valve and/or an installation comprising the valve, the method comprising connecting an assembly to the valve, wherein the assembly comprises:
a monitoring circuit configured to monitor the valve;
a sensor configured to measure a parameter of the assembly and/or a parameter of a fluid flowing through the valve and generate corresponding measurement data; and
a communication circuit configured to transmit the measurement data to the monitoring circuit,
wherein the monitoring circuit is configured to transmit the measurement data to a processor disposed outside the assembly and/or to generate diagnostic information regarding operation of the valve based on the measurement data.

32. The method of claim 31, wherein:
the assembly comprises a connector in which the sensor and the communication circuit are disposed; and
the connecting an assembly to the valve comprises fluidly connecting the connector to the valve, upstream or downstream of the valve with respect to a flow direction of a fluid through the valve.

33. The method of claim 31, wherein the sensor is configured to (A) measure (1) at least one parameter of a fluid flowing though the valve and/or (2) at least one parameter of the assembly, and (B) generate corresponding measurement data.

34. The method of claim 31, wherein the monitoring circuit is configured to measure at least one of a position of the valve, a control pressure in the valve, a current of the valve, and/or a local temperature of the valve.

35. The method of claim 31, wherein the monitoring circuit comprises a processor configured to:
generate diagnostic information regarding operation of the valve, based on the measurement data and the at least one operating condition of the valve; and
predict a change in at least one operating condition of the valve, based on a correlation of the sensor data and at least one characteristic of the valve, using a machine-learning algorithm.
